(19) United States
(12) Patent Application Publication
(10) Pub. No.: US 2021/0270193 A1
(43) Pub. Date: Sep. 2, 2021

(54) PHASE CHANGING UNIT AND VALVE TIMING CHANGING DEVICE

(71) Applicant: MIKUNI CORPORATION, Tokyo (JP)

(72) Inventors: Takeshi ONO, Kanagawa (JP); Kouji SUGANO, Kanagawa (JP); Yuuhei SANEKATA, Kanagawa (JP); Hiroki OTA, Kanagawa (JP); Toshinori INAFUNE, Kanagawa (JP)

(73) Assignee: MIKUNI CORPORATION, Tokyo (JP)

(21) Appl. No.: 17/261,565

(22) PCT Filed: Aug. 23, 2019
(86) PCT No.: PCT/JP2019/032979

§ 371 Date: Jan. 19, 2021

(30) Foreign Application Priority Data
Oct. 31, 2018 (JP) 2018-205170

(51) Int. Cl. F02D 13/02; F01L 1/344

(52) U.S. Cl. CPC F02D 13/0219; F01L 1/344; F01L 2810/04; F01L 2250/02; F01L 2820/032

(57) ABSTRACT

A phase changing unit of the present invention changes the relative rotational phase of a first rotating body and a second rotating body, and includes: a rotating member to which an external drive shaft is connected and to which a rotational driving force is applied; and a relative rotation mechanism that generates a relative rotation between a first rotating body and a second rotating body by the rotation of the rotating member. The rotating member includes: an action part that is made of metal and acts on the relative rotation mechanism; a connection part which is made of resin and to which the drive shaft is connected; and a fragile part that is made of resin and functions to cut the transmission of a rotational force between the drive shaft and the rotating member when an excessive load has occurred.

### BACKGROUND

### Technical Field

The present invention relates to a phase changing unit which changes rotational phases of two rotating bodies, and particularly relates to a phase changing unit which is applied when an opening/closing timing (a valve timing) of an intake valve or an exhaust valve of an internal combustion engine is changed, and a valve timing changing device using the phase changing unit.

### Related Art

As a conventional valve timing changing device, a valve timing changing device is known which includes: a driving rotating body that interlocks with the rotation of a crank shaft, a driven rotating body that integrally rotates with a cam shaft, a planet carrier, a planet gear, an electric motor that has a motor shaft, a movable shaft coupling mechanism that connects the motor shaft of the electric motor and the planet carrier, and the like (for example, see Patent literature 1).

Here, the movable shaft coupling mechanism is configured by two metal coupling members, plays a role in transmitting a rotational driving force of the electric motor to the planet carrier, and has a structure in which a low strength part arranged in the coupling member is damaged when an excessive torque has been generated.

However, structures of the movable shaft coupling mechanism and the planet carrier are complicated, machine processing for arranging the low strength part or the like for the coupling member is necessary, and an increase in cost is caused.

In addition, the motor shaft, the two coupling members, the planet carrier, and the like are made of metal and thus are a heavy object as a whole, and therefore, an inertial moment is large and a large output torque is required for the electric motor.

Furthermore, there is a risk that metal components impact with each other and an impact noise is generated during a torque variation or the like.

### LITERATURE OF RELATED ART

### Patent Literature

Patent literature 1: Japanese Patent No. 6314816

### SUMMARY

### Problems to be Solved

The present invention has been made in view of the above circumstances, and aims to provide a phase changing unit and a valve timing changing device using the phase changing unit that can solve problems of the conventional technology, achieve the simplification of structure, the reduction in weight, the reduction in noise, the reduction in cost, and the like, and prevent damage to an electric motor and the like even when an excessive load has occurred.

### Means to Solve Problems

A phase changing unit of the present invention, which changes a relative rotational phase of a first rotating body and a second rotating body that rotate around a predetermined axis line, includes: a rotating member to which an external drive shaft is connected and to which a rotational driving force is applied, and a relative rotation mechanism that generates a relative rotation between the first rotating body and the second rotating body by the rotation of the rotating member due to the rotational driving force of the external drive shaft. The rotating member includes: an action part that is made of metal and acts on the relative rotation mechanism; a connection part which is made of resin and to which the external drive shaft is connected; and a fragile part that is made of resin and functions to cut the transmission of a rotational force between the drive shaft and the rotating member when an excessive load has occurred.

In the phase changing unit, a configuration may be used in which with regard to the rotating member, a metal member including the action part and a resin member including the connection part and the fragile part are integrally bonded.

In the phase changing unit, a configuration may be used in which the rotating member is a molded article obtained in a way that the metal member and the resin member are integrally molded by insert molding.

In the phase changing unit, a configuration may be used in which the relative rotation mechanism includes: a first internal gear which integrally rotates with the first rotating body; and an external gear which is annular, rotates integrally or in-phase with the second rotating body, has the number of teeth different from that of the first internal gear, and is elastically deformable due to the action of the action part of the rotating member so as to partially mesh with the first internal gear.

In the phase changing unit, a configuration may be used in which the action part of the rotating member includes a cam surface which applies a cam action causing an elliptical deformation to the external gear.

In the phase changing unit, a configuration may be used in which the action part of the rotating member is fitted in the external gear via a bearing which is elliptically deformable.

In the phase changing unit, a configuration may be used in which the bearing includes: an inner ring which is annular, elastically deformable and in which the action part of the rotating member is fitted; an outer ring which is annular, elastically deformable and fitted in an inner side of the external gear; and a plurality of rolling bodies disposed between the inner ring and the outer ring.

In the phase changing unit, a configuration may be used in which a second internal gear is included which integrally rotates with the second rotating body and with which the external gear partially meshes.

In the phase changing unit, a configuration may be used in which the number of teeth of the second rotating body is the same as the number of teeth of the external gear.

In the phase changing unit, a configuration may be used in which the second rotating body includes a housing rotor which accommodates the relative rotation mechanism and the rotating member, and the second internal gear is attached in a way of rotating integrally with the housing rotor.

In the phase changing unit, a configuration may be used in which the housing rotor is supported so as to be rotatable around the axis line via the first internal gear.

In the phase changing unit, a configuration may be used in which a spacer member joined to the first rotating body is included, the first internal gear is fixed to the first rotating body via the spacer member, and the spacer member is formed in a way that a relative rotation range with respect to the housing rotor is controlled.

In the phase changing unit, a configuration may be used in which the housing rotor includes: a first housing which has a cylindrical shape and has a sprocket on an outer periphery; and a second housing which has a disk shape, is bonded to the first housing and has an opening part that exposes the connection part of the rotating member.

A valve timing changing device for an engine of the present invention includes a phase changing unit changing the relative rotational phase of a cam shaft and a housing rotor interlocking with a crank shaft, and changes an opening/closing timing of a valve for intake or exhaust driven by the cam shaft to an advanced angle side or a retarded angle side, wherein the phase changing unit is any phase changing unit having the configuration described above, a first rotating body included in the phase changing unit is the cam shaft, and a second rotating body included in the phase changing unit is the housing rotor.

In the valve timing changing device, a configuration may be used in which an electric motor is included which applies a rotational driving force to a rotating member included in the phase changing unit.

In the valve timing changing device, a configuration may be used in which the rotating member included in the phase changing unit is set to perform an advanced angle operation when the rotational driving force is applied at a rotational speed faster than a rotational speed of the cam shaft in a direction same as a rotational direction of the cam shaft.

### Effect

According to the phase changing unit having the above configuration, the simplification of structure, the reduction in weight, the reduction in noise, the reduction in cost, and the like can be achieved, and damage to an electric motor and the like can be prevented even when an excessive load has occurred.

### BRIEF DESCRIPTION OF THE DRAWINGS

FIG. 1 is an external perspective view in which a valve timing changing device using a phase changing unit according to an embodiment of the present invention is observed from diagonally front.

FIG. 2 is an exploded perspective view in which an electric motor is separated from the phase changing unit and observed from diagonally back in the valve timing changing device shown in FIG. 1.

FIG. 3 is a cross-sectional view of the valve timing changing device shown in FIG. 1.

FIG. 4 is a perspective cross-sectional view in which the phase changing unit of the present invention is in a state of being assembled to a cam shaft used as a first rotating body.

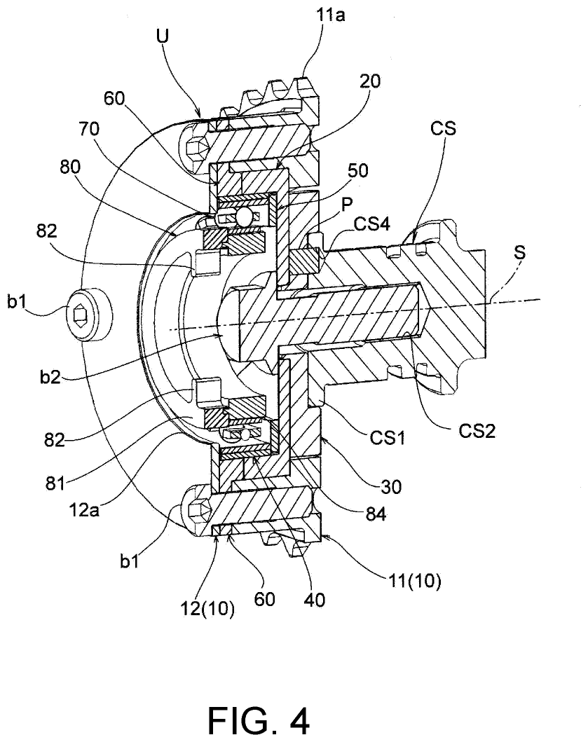

FIG. 5 is an exploded perspective view when observed from diagonally front, showing a relationship between the phase changing unit of the present invention and the cam shaft used as the first rotating body.

FIG. 6 is an exploded perspective view when observed from diagonally back, showing the relationship between the phase changing unit of the present invention and the cam shaft used as the first rotating body.

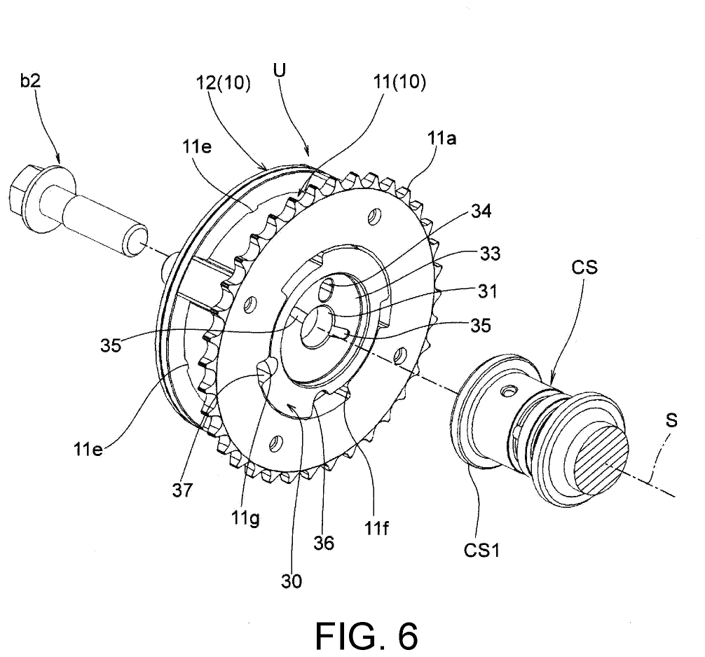

FIG. 7 is an exploded perspective view in which the phase changing unit of the present invention is observed from diagonally front.

FIG. 8 is an exploded perspective view in which the phase changing unit of the present invention is observed from diagonally back.

FIG. 9 is a perspective view showing an interrelationship of a rotating member, a bearing, an external gear, and a drive shaft of the electric motor included in the phase changing unit of the present invention.

FIG. 10 is a cross-sectional view showing the interrelationship of the rotating member, the bearing, the external gear, and the drive shaft of the electric motor included in the phase changing unit of the present invention.

FIG. 11 is an exploded perspective view showing a state in which a resin member and a metal member of the rotating member included in the phase changing unit of the present invention are separated.

FIG. 12 is a perspective cross-sectional view of the rotating member shown in FIG. 11.

FIG. 13 is an exploded perspective view showing another embodiment of a rotating member included in the phase changing unit of the present invention.

FIG. 14 is a perspective cross-sectional view of the rotating member shown in FIG. 13.

### DESCRIPTION OF THE EMBODIMENTS

Hereinafter, an embodiment of the present invention is described with reference to the drawings.

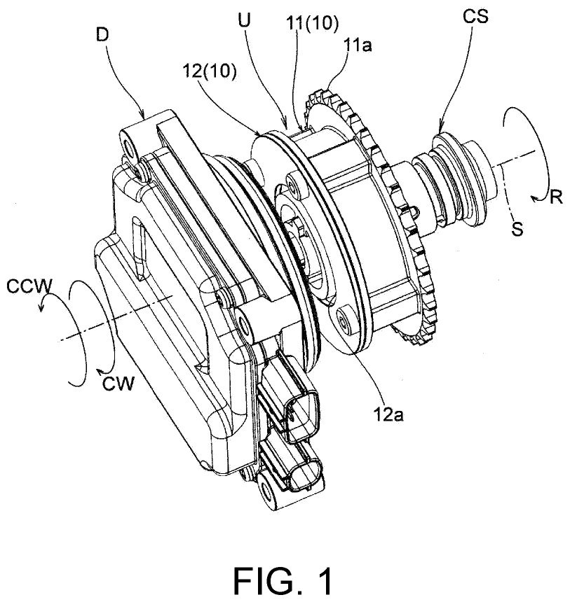

As shown in FIG. 1, a valve timing changing device according to an embodiment includes a phase changing unit U that changes a relative rotational phase of a cam shaft CS and a sprocket 11a.

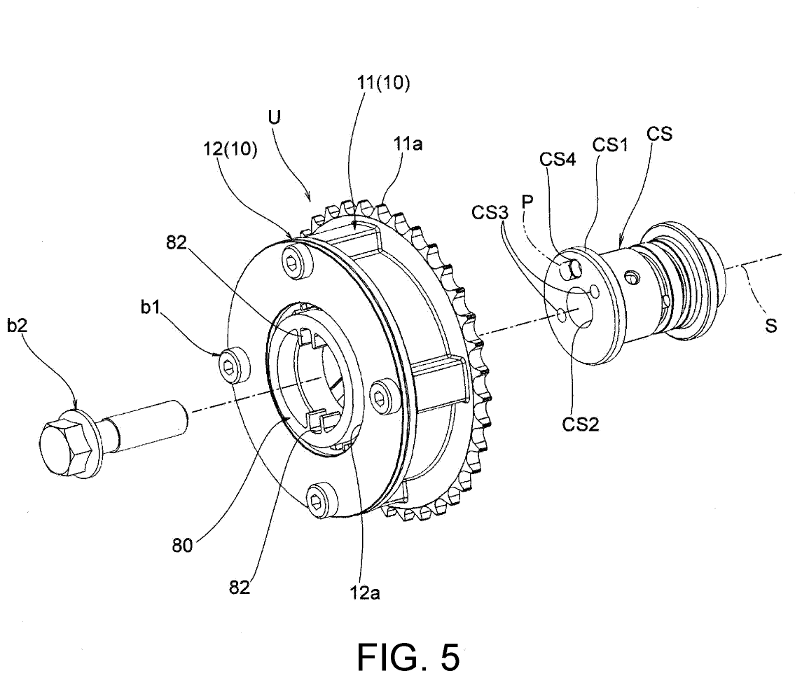

Here, the cam shaft CS functions as a first rotating body rotating in one direction (R direction in FIG. 1) around an axis line S and includes, as shown in FIG. 5, a flange-like fitting part CS1, a screw hole CS2, an oil passage CS3, and a fitting hole CS4 of a positioning pin P.

The sprocket 11a forms a part of a second rotating body rotating in one direction (the R direction) around the axis line S, and interlocks with the rotation of a crank shaft via a chain.

Besides, the phase changing unit U is appropriately driven and controlled by an electric motor D, and thereby an opening/closing timing (a valve timing) of an intake valve or an exhaust valve driven by the cam shaft CS is changed.

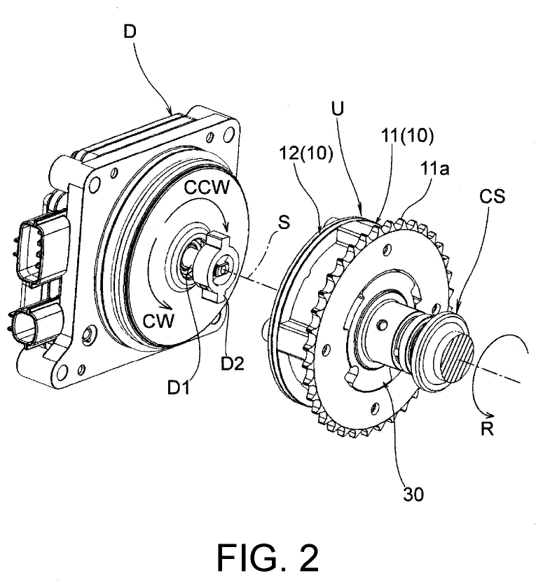

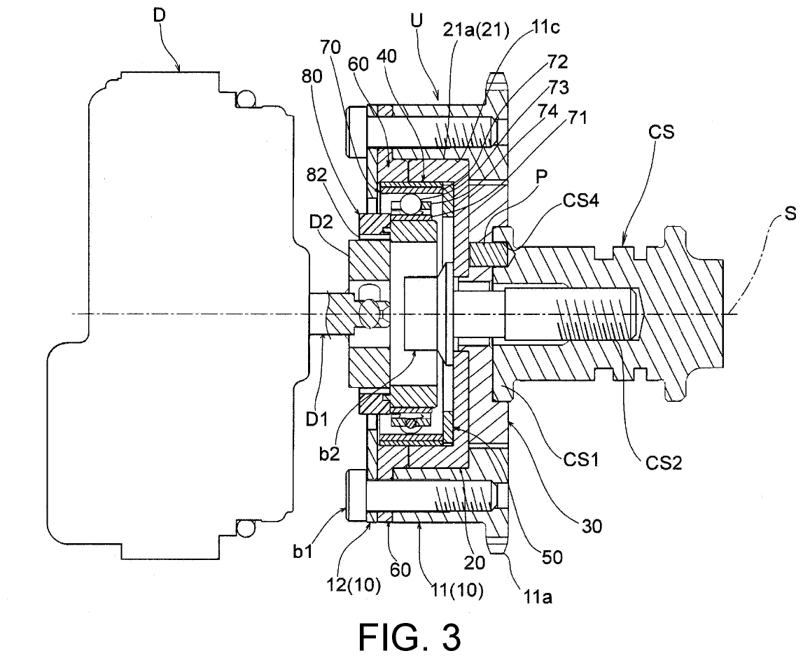

Here, the electric motor D is fixed to a part of an engine such as a chain cover member and includes, as shown in FIG. 2 and FIG. 3, a drive shaft D1 which generates a rotational driving force around the axis line S.

Besides, a connection frame D2 which forms a part of the drive shaft D1 is connected to a connection part 82 of a rotating member 80 included in the phase changing unit U, and applies a rotational driving force.

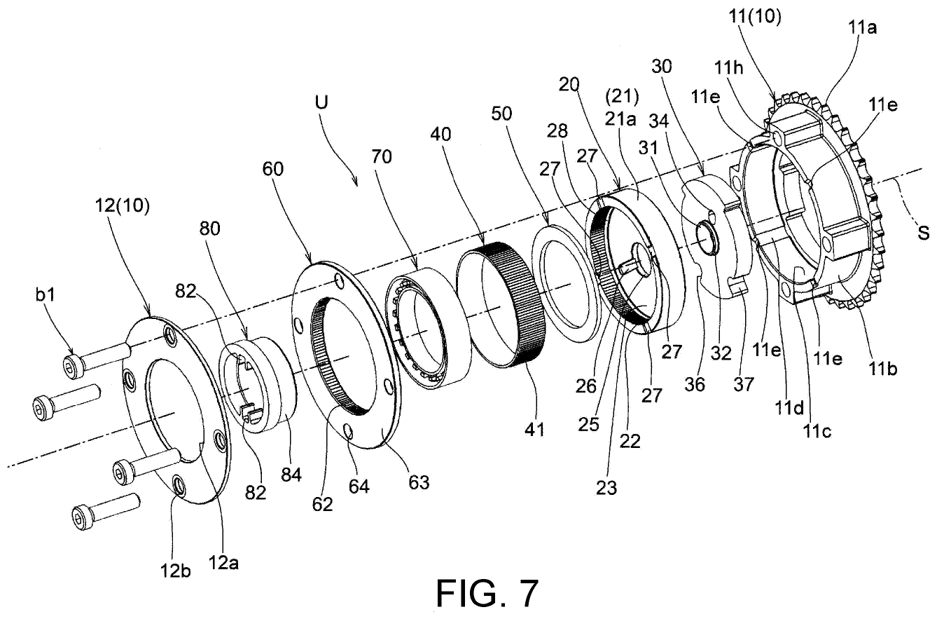

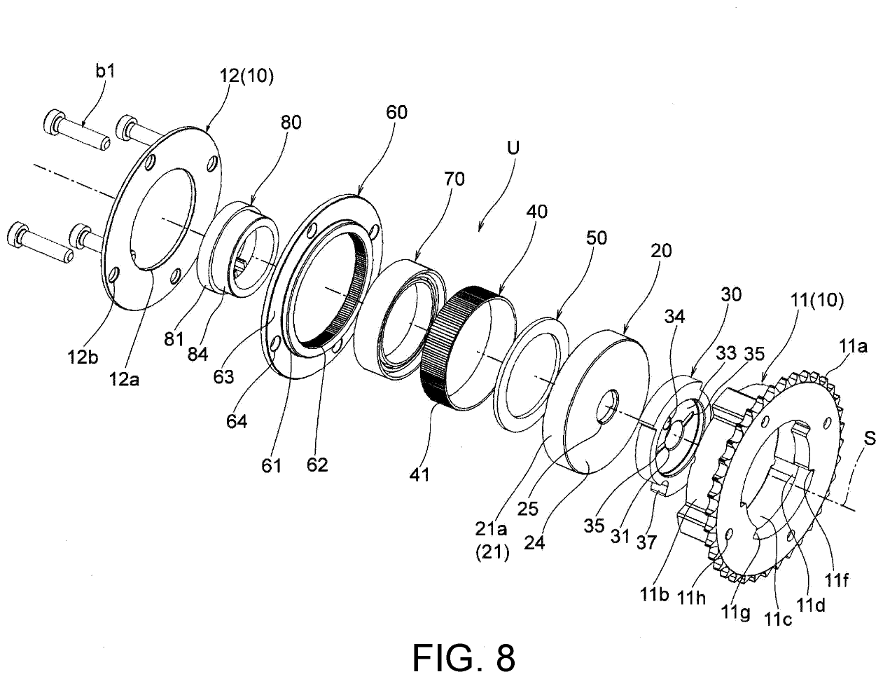

As shown in FIG. 3, FIG. 7, and FIG. 8, the phase changing unit U includes a housing rotor 10 used as the second rotating body, a first internal gear 20, a rotor 30 used as a spacer member, an external gear 40, a spacer member 50, a second internal gear 60, a bearing 70, and the rotating member 80.

Here, the first internal gear 20 and the external gear 40 constitute a relative rotation mechanism, which generates a relative rotation between the cam shaft CS used as the first rotating body and the housing rotor 10 used as the second rotating body by the rotation of the rotating member 80.

The housing rotor 10 includes a first housing 11 which is supported in a way of rotating freely around the axis line S, and a second housing 12 which is bonded to the first housing 11 by screws b1.

The first housing 11 is formed in a substantially cylindrical shape by using a metal material, and includes the sprocket 11a, a cylindrical part 11b, an inner peripheral surface 11c, oil passages 11d and 11e, an advanced angle side stopper 11f, a retarded angle side stopper 11g, and a plurality of screw holes 11h into which the screws b1 are screwed.

The inner peripheral surface 11c comes into close contact with an outer peripheral surface 21a of the first internal gear 20 in a way of sliding freely, and is supported in a way of rotating freely around the axis line S.

The oil passage 11d is formed as a groove extending parallel to the axis line S on the inner peripheral surface 11c. In addition, the oil passage 11d guides lubricating oil to a slide region of the outer peripheral surface 21a of the first internal gear 20 and the inner peripheral surface 11c, wherein the lubricating oil has passed through the oil passage CS3 of the cam shaft CS and an oil passage 35 of the rotor 30 and has been guided to the inside of the first internal gear 20.

The oil passage 11e is formed as a groove extending radially outward on a front end surface of the cylindrical part 11b. Besides, the oil passage 11e guides lubricating oil which has been guided into the housing rotor 10 to the outside of the housing rotor 10.

The advanced angle side stopper 11f abuts against an advanced angle side abutting part 36 of the rotor 30, and positions the cam shaft CS in a maximum advanced angle position. The retarded angle side stopper 11g abuts against a retarded angle side abutting part 37 of the rotor 30, and positions the cam shaft CS in a maximum retarded angle position.

The second housing 12 is formed in a disk shape by using a metal material, and includes a circular opening part 12a centered on the axis line S and a plurality of circular holes 12b through which the screws b1 pass.

The opening part 12a is formed to leave a gap around the rotating member 80 in a radial direction and expose the connection part 82 of the rotating member 80.

Further, after the first internal gear 20 to which the rotor 30 is fitted, the spacer member 50, the second internal gear 60, and the rotating member 80 to which the external gear 40 and the bearing 70 are fitted are assembled to the first housing 11, the second housing 12 is bonded to the first housing 11 by the screws b1, and thereby the housing rotor 10 is formed which is used as the second rotating body rotating around the axis line S.

Here, the housing rotor 10 is supported so as to be rotatable around the axis line S via the first internal gear 20, and thus positioning of the housing rotor 10, the external gear 40, and the second internal gear 60 can be performed on the basis of the first internal gear 20 which is fixed to the cam shaft CS.

In addition, the housing rotor 10 uses a configuration including the first housing 11 and the second housing 12, the above various components are accommodated in the first housing 11 and the second housing 12 is bonded to the first housing 11, and thereby the phase changing unit U can be easily assembled.

As shown in FIG. 7 and FIG. 8, for example, the first internal gear 20 is formed in a bottomed cylindrical shape by forging using a metal material, and includes a cylindrical part 21, a row of teeth 22, a bottom wall surface 23, a joint surface 24, a fitting hole 25, oil passages 26 and 27, and an inner peripheral corner R part 28.

The cylindrical part 21 defines the outer peripheral surface 21a centered on the axis line S in order to come into contact with the inner peripheral surface 11c of the first housing 11 in a way of sliding freely.

The row of teeth 22 consists of the number of teeth Z1, and is arrayed and formed in a ring shape centered on the axis line S on an inner peripheral surface of the cylindrical part 21.

The bottom wall surface 23 is formed as a flat surface perpendicular to the axis line S, and functions as a seat surface of a fastening bolt b2 while the spacer member 50 is disposed in a way of abutting on the bottom wall surface 23.

The joint surface 24 is formed as a flat surface parallel to the bottom wall surface 23 so that the rotor 30 is joined to the joint surface 24.

The fitting hole 25 is formed in a circular shape centered on the axis line S, and formed in a way that a tubular fitting part 32 of the rotor 30 is fitted to the fitting hole 25.

The oil passage 26 is formed as a groove extending in a radial direction on the bottom wall surface 23. Besides, the oil passage 26 guides, to the inside of the first internal gear 20, lubricating oil which has passed through the oil passage 35 of the rotor 30 and an inner side of the tubular fitting part 32.

The oil passage 27 is formed as a groove extending in a radial direction on a front end surface of the cylindrical part 21. Besides, the oil passage 27 guides the lubricating oil in the first internal gear 20 to the oil passages 11d and 11e of the first housing 11.

The inner peripheral corner R part 28 is a region which is curved and formed in a region connected to the inner peripheral surface of the cylindrical part 21 from a peripheral edge of the bottom wall surface 23, and is a region in which no row of teeth 22 exists in a direction of the axis line S.

The rotor 30 is formed in a substantially flat plate shape by using a metal material and includes, as shown in FIG. 7 and FIG. 8, a through hole 31, the tubular fitting part 32, a fitting recess part 33, a positioning hole 34, the oil passage 35, the advanced angle side abutting part 36, and the retarded angle side abutting part 37.

The through hole 31 is formed in a circular shape centered on the axis line S to leave a gap in which lubricating oil flows and allow the fastening bolt b2 to pass through.

The tubular fitting part 32 is formed in a cylindrical shape centered on the axis line S to define a part of the through hole 31 and be fitted to the fitting hole 25 of the first internal gear 20, and so as not to block the oil passage 26 in the fitted state.

The fitting recess part 33 is formed in a circular shape centered on the axis line S so that the fitting part CS1 of the cam shaft CS is fitted to the fitting recess part 33.

The positioning hole 34 is formed in a way that the positioning pin P is fitted which is fixed to the fitting hole CS4 of the cam shaft CS in order to position an angular position around the axis line S.

The oil passage 35 is formed as a groove which extends in a radial direction, communicates with the through hole 31, and communicates with the oil passage CS3 of the cam shaft CS on a bottom wall surface of the fitting recess part 33.

Besides, the oil passage 35 guides lubricating oil supplied from the oil passage CS3 of the cam shaft CS into the first internal gear 20 through the through hole 31.

The advanced angle side abutting part 36 is formed in a way of separably abutting against the advanced angle side stopper 11f of the first housing 11.

The retarded angle side abutting part 37 is formed in a way of separably abutting against the retarded angle side stopper 11g of the first housing 11.

Besides, the tubular fitting part 32 is fitted to the fitting hole 25, and thereby the rotor 30 is integrally assembled to the first internal gear 20 previously.

Next, in a state that the first housing 11 is rotatably attached to the first internal gear 20, the rotor 30 approaches the cam shaft CS, the positioning pin P is fitted to the positioning hole 34, and the fitting part CS1 is fitted to the fitting recess part 33. Thereby, the rotor 30 is joined to the cam shaft CS.

Then, the fastening bolt b2 passes through the through hole 31 and is screwed into the screw hole CS2, and thereby the first internal gear 20 is fixed to the cam shaft CS via the rotor 30.

In addition, the advanced angle side abutting part 36 abuts against the advanced angle side stopper 11f, and thereby the rotor 30 is positioned in the maximum advanced angle position. The retarded angle side abutting part 37 abuts against the retarded angle side stopper 11g, and thereby the rotor 30 is positioned to the maximum retarded angle position.

That is, with regard to the cam shaft CS, a relative rotation range with respect to the housing rotor 10 is controlled via the rotor 30.

Thereby, a range of rotational phase in which the valve timing can be changed, that is, a range of angle which can be adjusted from the maximum retarded angle position to the maximum advanced angle position can be controlled to a desired range.

In this way, the rotor 30 used as the spacer member is used, and thereby when a shape of the fitting part CS1 of the cam shaft CS is different depending on the specification of the engine, the phase changing unit U can be applied to valve timing changing devices for various engines simply by setting the rotor 30 corresponding to various cam shafts CS.

As shown in FIG. 7 and FIG. 8, the external gear 40 is formed in a cylindrical shape which is elastically deformable and has a thin wall thickness by using a metal material, and includes a row of teeth 41 on an outer peripheral surface of the external gear 40.

The row of teeth 41 consists of the number of teeth Z2 different from the number of teeth Z1 of the first internal gear 20, substantially half of a back side region in the direction of the axis line S meshes with the row of teeth 22 of the first internal gear 20, and substantially half of a front side region in the direction of the axis line S meshes with a row of teeth 62 of the second internal gear 60.

Here, the “front side” is referred to as a left side in the direction of the axis line S in FIG. 3, and the “back side” is referred to as a right side in the direction of the axis line S in FIG. 3.

Besides, the external gear 40 receives a cam action of an action part 84 of the rotating member 80 via the bearing 70 and thereby is deformed into an elliptical shape, partially meshes with the first internal gear 20 in two places, and partially meshes with the second internal gear 60 in two places.

As shown in FIG. 7 and FIG. 8, the spacer member 50 is formed in a ring shape which forms a flat plate by using a metal material, and is formed in a way of having a thickness which is equal to or larger than a length dimension of the inner peripheral corner R part 28 of the first internal gear 20 in the direction of the axis line S.

Besides, the spacer member 50 is assembled in a way of coming into contact with the bottom wall surface 23 of the first internal gear 20, and plays a role of receiving an end surface of the external gear 40 in the direction of the axis line S and controlling the external gear 40 to enter an inner peripheral corner R part 28 side.

In this way, the spacer member 50 is used, and thereby additional cutting operations and the like are not required in the first internal gear 20, and the reduction in cost can be achieved as a whole.

Moreover, when there is no inner peripheral corner R part 28 in the first internal gear 20 and a circular groove is formed in an inner peripheral corner region, or when the row of teeth 22 is formed in a whole region in the direction of the axis line S, the spacer member 50 may be eliminated.

As shown in FIG. 7 and FIG. 8, for example, the second internal gear 60 is formed in a substantially ring shape by forging using a metal material, and includes a cylindrical part 61 centered on the axis line S, the row of teeth 62, a flange part 63, and a plurality of circular holes 64 through which the screws b1 pass.

The cylindrical part 61 is formed in an outer diameter dimension with which the cylindrical part 61 is fitted to the inner peripheral surface 11c of the first housing 11. The row of teeth 62 consists of the number of teeth Z3, and is arrayed and formed in a ring shape centered on the axis line S on an inner peripheral surface of the cylindrical part 61.

Besides, the row of teeth 62 is disposed in a way of meshing with substantially half of the front side region of the row of teeth 41 of the external gear 40 in the direction of the axis line S.

Here, the number of teeth Z3 of the row of teeth 62 is set to be the same as the number of teeth Z2 of the row of teeth 41 of the external gear 40. In this way, the number of teeth Z3 and the number of teeth Z2 are set to be the same (Z3=Z2), and thereby a speed change ratio (for example, a speed reduction ratio) when the rotational phase is changed can be easily set simply by the number of teeth Z1 of the first internal gear 20 and the number of teeth Z2 of the external gear 40.

The flange part 63 is formed in a flat plate shape perpendicular to the axis line S, and is assembled in a way of being sandwiched between the first housing 11 and the second housing 12.

That is, the second internal gear 60 is fixed by the screws b1 in a way of integrally rotating with the housing rotor 10, and meshes with the external gear 40.

In this way, the second internal gear 60 is used which is connected in a way of integrally rotating with the housing rotor 10 and with which the external gear 40 partially meshes, and thereby compared to a case in which the external gear 40 is directly fixed to the housing rotor 10, the external gear 40 can be formed in a simple form of an annular shape, and the manufacturing cost of the external gear 40 can be reduced.

In addition, the second internal gear 60 is formed independently from the housing rotor 10 and is retrofitted to a housing rotor 0, and thus compared to a case in which the second internal gear 60 is integrally formed with the housing rotor 10, manufacture can be easy and productivity can be improved.

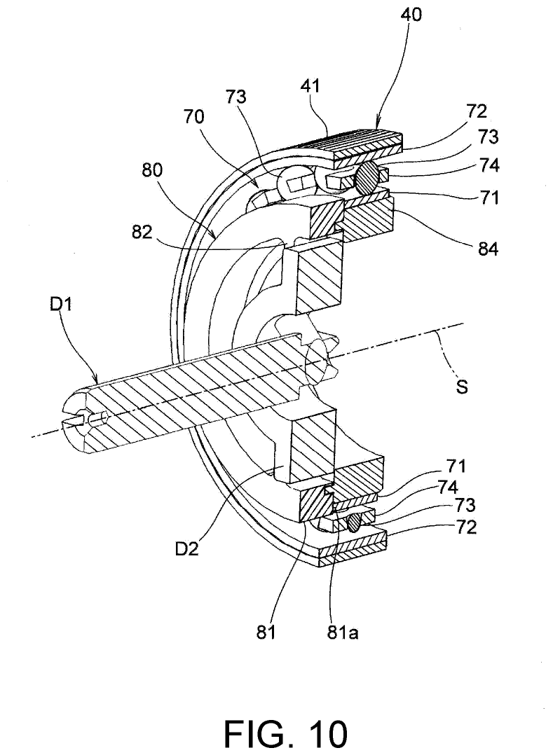

As shown in FIG. 3 and FIG. 10, the bearing 70 includes an annular inner ring 71, an annular outer ring 72, a plurality of rolling bodies 73 which are disposed to roll freely between the inner ring 71 and the outer ring 72, and a retainer 74 which holds the plurality of rolling bodies 73.

The inner ring 71 is formed in an endless belt shape which is elastically deformable using a metal material, and the action part 84 of the rotating member 80 is fitted to the inner ring 71.

The outer ring 72 is formed in an endless belt shape which is elastically deformable using a metal material, and is fitted to an inner side of the external gear 40.

The plurality of rolling bodies 73 are formed into spherical bodies by using a metal material, sandwiched between the inner ring 71 and the outer ring 72, and held at equal intervals around the axis line S by the retainer 74.

The retainer 74 is formed in an endless belt shape which is elastically deformable using a metal material, and formed so as to hold the plurality of rolling bodies 73 to roll freely at equal intervals.

Besides, the outer ring 72 of the bearing 70 is deformed into an elliptical shape in accordance with the cam action of the action part 84 of the rotating member 80.

In this way, the bearing 70 is interposed between the action part 84 of the rotating member 80 and the external gear 40 in a state of being elliptically deformed, and thus along with the rotation of the rotating member 80, the external gear 40 can be elliptically deformed smoothly.

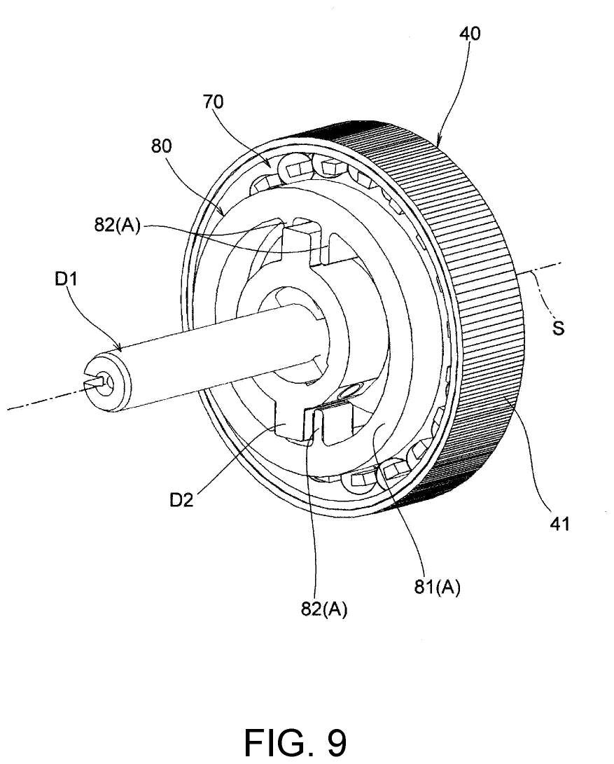

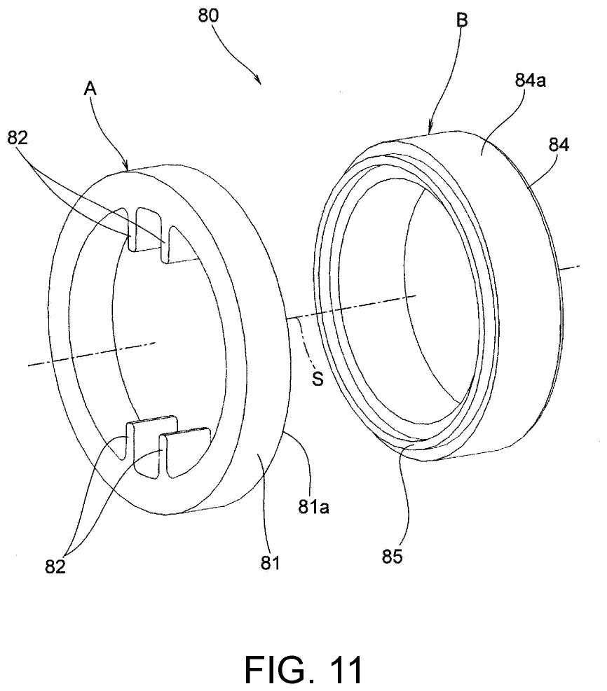

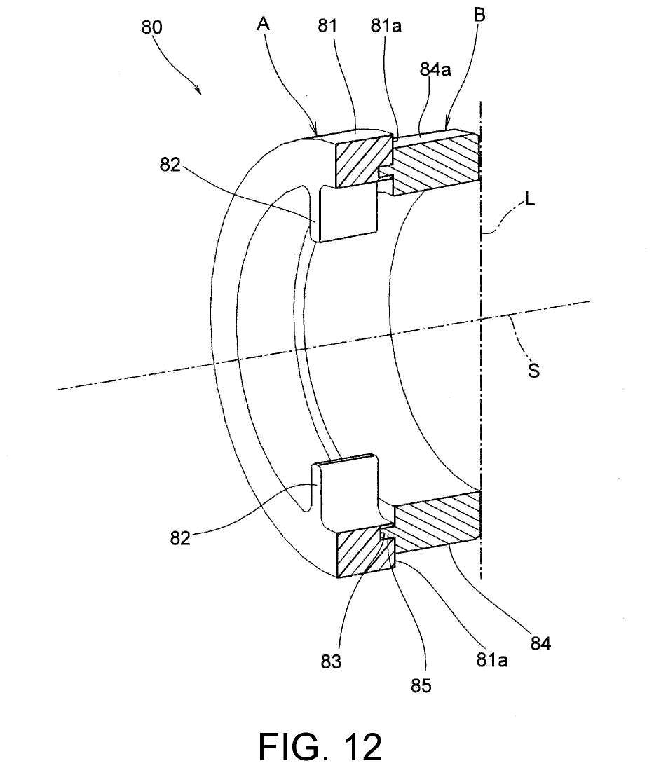

As shown in FIG. 9, FIG. 11 and FIG. 12, the rotating member 80 includes a resin member A which is formed using a resin material, and a metal member B which is formed using a metal material.

Besides, the rotating member 80 is a rotating member to which the connection frame D2 forming a part of the external drive shaft D1 is connected and to which the rotational driving force is applied. In addition, the rotating member 80 rotates, and thereby the action part 84 applies the cam action, the external gear 40 is elliptically deformed which is in a state of meshing with the first internal gear 20 and the second internal gear 60, and the meshing position changes continuously around the axis line S.

For example, the resin member A is formed by a mold obtained by injection molding of resin, and includes an annular part 81, the connection part 82, and an annular groove 83 in which an annular rib 85 of the metal member B is embedded.

For example, the metal member B is formed by sintering, and includes the action part 84, and the annular rib 85 which protrudes on a front end surface of the action part 84 in the direction of the axis line S.

The annular part 81 is formed in a circular shape centered on the axis line S.

The connection part 82 is formed as a U-shaped rib which opens toward a center in a radial direction perpendicular to the axis line S on an inner side of the annular part 81.

Besides, the connection frame D2 which forms a part of the drive shaft D1 is inserted and connected to the connection part 82.

In addition, the connection part 82 functions to cut the transmission of a rotational force between the drive shaft D1 and the rotating member 80 when an excessive load has occurred, and specifically functions as a fragile part which breaks.

The action part 84 is formed in an elliptical annular shape, and an outer peripheral surface of the action part 84 defines an elliptical cam surface 84a which has a long axis in a direction of a straight line L perpendicular to the axis line S.

The cam surface 84a applies the cam action causing an elliptical deformation to the external gear 40.

The annular rib 85 is formed in a way of being embedded in the annular groove 83 of the resin member A, and plays a role of improving a bonding force between the resin member A and the metal member B.

Here, an outer diameter in a long axis direction of the action part 84 is formed to be smaller than an outer diameter of the annular part 81 having a circular shape. Thus, in a boundary region of the resin member A and the metal member B, an annular end surface 81a is defined.

The annular end surface 81a plays a role of positioning the inner ring 71 in the direction of the axis line S when the bearing 70 is fitted.

The rotating member 80 configured by the resin member A and the metal member B is formed as follows.

Firstly, the metal member B is previously formed by sintering or the like.

Next, in a state that the metal member B is disposed in a mold of resin molding, a resin material is injected in the mold, and insert molding is performed.

Thereby, the rotating member 80 is formed which is a molded article obtained in a way that the resin member A and the metal member B are integrally molded.

In this way, the rotating member 80 is a rotating member obtained in a way that the resin member A and the metal member B are integrally bonded, and the connection frame D2 which forms a part of the drive shaft D1 is connected to the resin connection part 82 of the rotating member 80 and transmits a rotational driving force, and thus the occurrence of an impact noise or the like which may be generated when metal components impact with each other can be suppressed or prevented.

In addition, in the phase changing unit U, when an excessive load has occurred, the connection part 82 which is used as a resin fragile part of the rotating member 80 functions to cut the transmission of the rotational force between the drive shaft D1 and the rotating member 80, and thus damage to the electric motor D including the drive shaft D1 and the like can be prevented.

In addition, a part of the rotating member 80 is formed as the resin member A, and thus man-hour for machine processing of the rotating member 80 can be reduced, and therefore the reduction in cost can be achieved.

In addition, the reduction in weight of the rotating member 80 can be achieved and an inertial moment can be reduced, and thus the power saving of the electric motor D can be achieved.

Furthermore, the resin member A and the metal member B are integrally molded by the insert molding, and thus a screw, a bonding agent, or the like for bonding is not required, and resin molding can be easily performed to the shape of a connection part corresponding to various drive shafts D1.

A relationship between the first internal gear 20 and the external gear 40 which constitute the relative rotation mechanism and the second internal gear 60 is described.

The relationship between the number of teeth Z1 of the first internal gear 20 and the number of teeth Z2 of the external gear 40 is set in a way that a relationship of Z2=Z1±n·N is established when the number of meshing places between the first internal gear 20 and the external gear 40 is set as N and a positive integer is set as n, so that a relative rotation is generated. In the embodiment, because N=2, for example, Z1 is set to 162 and Z2 is set to 160.

In addition, the relationship between the number of teeth Z3 of the second internal gear 60 and the number of teeth Z2 of the external gear 40 is set in a way that the number of teeth Z3 is the same value as the number of teeth Z2 so as to make the second internal gear 60 and the external gear 40 rotate in-phase without generating a relative rotation as mentioned earlier. In the embodiment, for example, Z3 is set to 160 and Z2 is set to 160.

Thereby, the speed reduction ratio can be determined simply by the number of teeth Z1 of the first internal gear 20 and the number of teeth Z2 of the external gear 40, and thus setting of the speed reduction ratio is easy.

Moreover, the number of teeth Z3 of the second internal gear 60 may not be the same as the number of teeth Z2 of the external gear 40 and may be a different value.

Next, an assembly operation of the phase changing unit U having the above configuration is described.

During the assembly operation, the first housing 11, the second housing 12, the screw b1, the first internal gear 20, the rotor 30, the external gear 40, the spacer member 50, the second internal gear 60, the bearing 70, and the rotating member 80 are prepared.

Firstly, the bearing 70 and the external gear 40 are assembled to the rotating member 80.

Next, the rotor 30 is joined and integrally assembled to the first internal gear 20.
Next, the first internal gear 20 is fitted to the first housing 11, and the spacer member 50 is fitted from the outer front of the first internal gear 20.

Next, the rotating member 80 is fitted in a way that a back side portion of the row of teeth 41 of the external gear 40 is meshed with the row of teeth 22 of the first internal gear 20. Next, the second internal gear 60 is fitted in a way that the row of teeth 62 is meshed with a front side portion of the row of teeth 41 of the external gear 40, and the second housing 12 is disposed from the outer front of the second internal gear 60.

Besides, the screw b1 passes through the circular holes 12b and 64 and is screwed into the screw hole 11h, and thereby the second housing 12 is bonded to the first housing 11 with the second internal gear 60 sandwiched therebetween.

Thereby, the assembly of the phase changing unit U is completed. In addition, in the assembly state, the connection part 82 of the rotating member 80 comes into a state of being exposed through the opening part 12a of the housing rotor 10.

Moreover, the assembly operation is not limited to the above procedure, and may use other procedures.

According to the phase changing unit U having the above configuration, the simplification of structure, the reduction in weight, the reduction in noise, the reduction in cost, the facilitation of assembly operation, and the like can be achieved, and even when an excessive load has occurred, damage to the electric motor D and the like can be prevented.

Next, operations when the phase changing unit U is applied as a valve timing changing device for an engine are described.

Firstly, when a phase change is not performed, that is, when a valve timing is not changed, the electric motor D is driven and controlled in a way of applying a rotational driving force to the rotating member 80 at a rotational speed the same as a rotational speed of the cam shaft CS in the same direction as the cam shaft CS.

Thus, the first internal gear 20 and the external gear 40 are locked in a position in which the first internal gear 20 and the external gear 40 have meshed with each other.

In addition, the external gear 40 and the second internal gear 60 are locked in a position in which the external gear 40 and the second internal gear 60 have meshed with each other.

Thereby, the cam shaft CS and the housing rotor 10 integrally rotate in one direction (the R direction in FIG. 1) around the axis line S.

Meanwhile, when the phase is changed, that is, when the valve timing is changed, the electric motor D is driven and controlled in a way of applying a rotational driving force to the rotating member 80 at a rotational speed different from the rotational speed of the cam shaft CS in the same direction as the cam shaft CS.

For example, if the electric motor D is driven and controlled in a way of applying a rotational driving force to the rotating member 80 at a rotational speed faster than the rotational speed of the cam shaft CS in the same direction as the cam shaft CS, the rotating member 80 will be relatively rotated in one direction (CW direction in FIG. 1) around the axis line S, and thereby the action part 84 of the rotating member 80 will rotate in one direction and apply a cam action to the external gear 40.
Besides, if the rotating member 80 makes one rotation in one direction, the external gear 40 will generate a rotation difference corresponding to a difference in the number of teeth (162-160) with respect to the first internal gear 20, and shift to another direction (CCW direction in FIG. 1).
Meanwhile, even when the rotating member 80 rotates in one direction, the number of teeth Z2 of the external gear 40 and the number of teeth Z3 of the second internal gear 60 are the same, and thus the same phase is held.

That is, the rotating member 80 is continuously rotated a plurality of times in one direction (the CW direction), and thereby a rotational phase of the cam shaft CS is advanced with respect to the housing rotor 10, and an opening/closing timing of an intake valve or an exhaust valve is changed to the advanced angle side.

Meanwhile, if the electric motor D is driven and controlled in a way of applying a rotational driving force to the rotating member 80 at a rotational speed slower than the rotational speed of the cam shaft CS in the direction same as the cam shaft CS, the rotating member 80 will be relatively rotated in another direction (the CCW direction in FIG. 1) around the axis line S, and the action part 84 of the rotating member 80 will rotate in another direction and apply a cam action to the external gear 40.

Besides, if the rotating member 80 makes one rotation in another direction, the external gear 40 will generate a rotation difference corresponding to a difference in the number of teeth (162-160) with respect to the first internal gear 20, and shift to one direction (the CW direction in FIG. 1). Meanwhile, even when the rotating member 80 rotates in another direction, the number of teeth Z2 of the external gear 40 and the number of teeth Z3 of the second internal gear 60 are the same, and thus the same phase is held.

That is, the rotating member 80 is continuously rotated a plurality of times in another direction (the CCW direction), and thereby a rotational phase of the cam shaft CS is retarded with respect to the housing rotor 10, and an opening/closing timing of an intake valve or an exhaust valve is changed to the retarded angle side.

During the change operation, the connection frame D2 of the drive shaft D1 is connected to the resin connection part 82 of the rotating member 80 and transmits a rotational driving force, and thus the occurrence of an impact noise or the like which may be generated when metal components impact with each other is suppressed or prevented.

In addition, in the phase changing unit U, when an excessive load has occurred, the connection part 82 which is used as a resin fragile part of the rotating member 80 breaks.
Thereby, the transmission of the rotational force between the phase changing unit U and the drive shaft D1 is cut, and thus damage to the electric motor D including the drive shaft D1 and the like are prevented.

Here, the rotating member 80 is set to perform an advanced angle operation when the rotational driving force is applied by the electric motor D at a rotational speed faster than the rotational speed of the cam shaft CS in the direction (the CW direction) the same as the rotational direction (the R direction) of the cam shaft.

Thus, when the phase changing unit U is arranged corresponding to the intake valve, even if the electric motor D is inoperative, the rotational phase will be automatically changed to the retarded angle side, and thus startability of the engine can be maintained.

Next, a lubrication action in the phase changing unit U is described.

The lubricating oil stored in an oil pan of the engine is guided to the oil passage CS3 of the cam shaft CS by an oil pump or the like.
The lubricating oil which has been guided to the oil passage CS3 passes through the oil passage 35 and the through hole 31 of the rotor 30, and the oil passage 26 of the first internal gear 20, and is guided to the inside of the first internal gear 20.

The lubricating oil which has been guided to the inside of the first internal gear 20 is supplied to the bearing 70, and is supplied to a meshing region of the external gear 40 and the first internal gear 20 and a meshing region of the external gear 40 and the second internal gear 60.

Then, the lubricating oil is guided to the outside of the phase changing unit U from the opening part 12a of the second housing 12, flows through the inside of the chain cover member, and is returned to the oil pan.

In addition, the lubricating oil which flows out from the opening part 12a also contributes to a lubrication action for a connection region between the connection part 82 of the rotating member 80 and the connection frame D2 of the drive shaft D1, and thus an abrasion, an impact noise, or the like in the connection region is suppressed.

Meanwhile, by a centrifugal force, the lubricating oil in the first internal gear 20 passes through the oil passage 27 of the first internal gear 20 and the oil passage 11d of the first housing 11, and is supplied to a slide surface between the inner peripheral surface 11c of the first housing 11 and the outer peripheral surface 21a of the first internal gear 20.

Then, by a centrifugal force, the lubricating oil passes through the oil passage 11e of the first housing 11, is guided to the outside of the phase changing unit U, flows through the inside of the chain cover member, and is returned to the oil pan.
In this way, according to the phase changing unit U of the present invention, the lubrication action is also reliably performed, and thus a smooth phase change operation can be achieved, and an abrasion or a deterioration of the slide region can be suppressed.

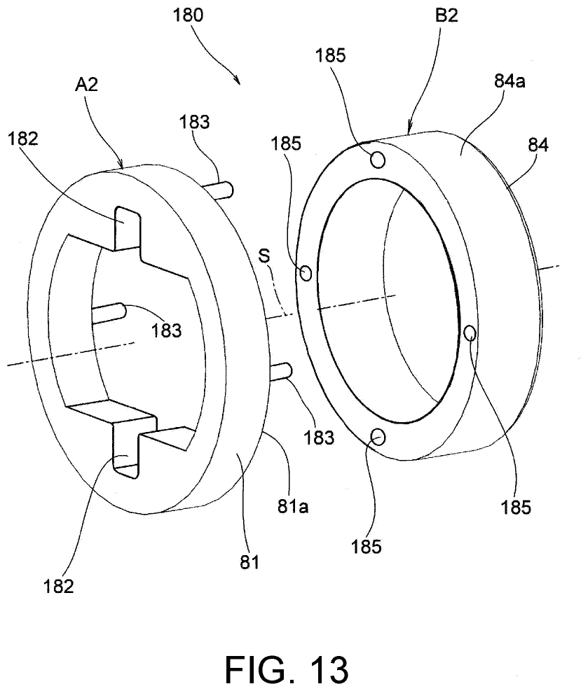

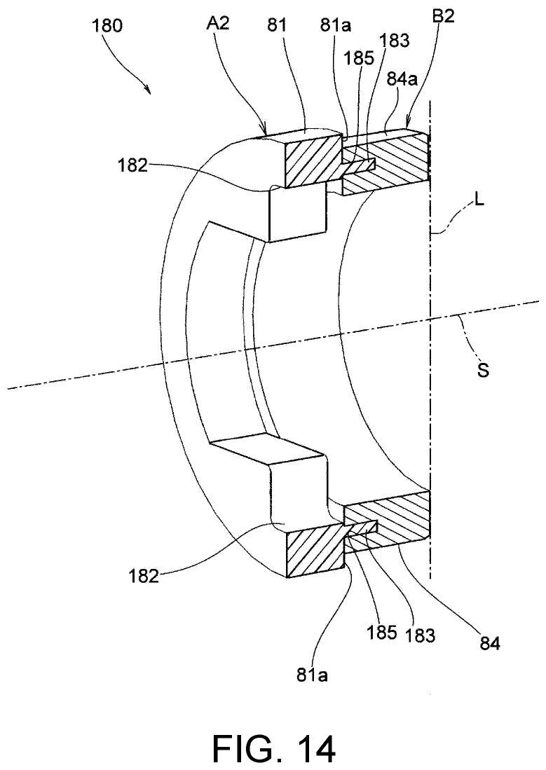

FIG. 13 and FIG. 14 are diagrams showing another embodiment of a rotating member which is included in the phase changing unit of the present invention, the same configurations as the embodiment described above are marked with the same signs, and descriptions are omitted. A rotating member 180 according to the embodiment includes a resin member A2 which is formed using a resin material, and a metal member B2 which is formed using a metal material.

For example, the resin member A2 is formed by a mold obtained by injection molding of resin, and includes the annular part 81, a connection part 182, and a fragile part 183. For example, the metal member B2 is formed by sintering, and includes the action part 84, and a bonding hole 185 which opens to an end surface of the action part 84 and extends in the direction of the axis line S.

The connection part 182 is formed as a U-shaped groove which opens toward a center in a radial direction perpendicular to the axis line S on the inner side of the annular part 81, and the periphery of the U-shaped groove is built up to improve mechanical strength.

Besides, the connection frame D2 which forms a part of the drive shaft D1 is inserted and connected to the connection part 182.
The fragile part 183 is formed in a rod shape which protrudes from a back end surface of the annular part 81 in the direction of the axis line S, and is disposed in the bonding hole 185 of the metal member B2.
Besides, the fragile part 183 functions to cut the transmission of a rotational force between the drive shaft D1 and the rotating member 180 when an excessive load has occurred. Specifically, the fragile part 183 functions to break in a position of an end surface 81a.
Here, the number of the fragile part 183 and the bonding hole 185 is appropriately selected depending on required mechanical strength.

The rotating member 180 configured by the resin member A2 and the metal member B2 is formed as follows.

Firstly, the metal member B2 is previously formed by sintering or the like.
Next, in a state that the metal member B2 is disposed in a mold of resin molding, a resin material is injected in the mold, and insert molding is performed.
Thereby, the rotating member 180 is formed which is a molded article obtained in a way that the resin member A2 and the metal member B2 are integrally molded.

In this way, the rotating member 180 is a rotating member which is obtained in a way that the resin member A2 and the metal member B2 are integrally bonded, and the connection frame D2 which forms a part of the drive shaft D1 is connected to the resin connection part 182 of the rotating member 180 and transmits a rotational driving force, and thus the occurrence of an impact noise or the like which may be generated when metal components impact with each other can be suppressed or prevented.

In addition, in the phase changing unit U, when an excessive load has occurred, the resin fragile part 183 of the rotating member 180 functions to cut the transmission of the rotational force between the drive shaft D1 and the rotating member 180, and thus damage to the electric motor D including the drive shaft D1 and the like can be prevented.
Here, even if the fragile part 183 breaks, the fragile part 183 will remain in the bonding hole 185 of the metal member B2, and thus no broken piece will be produced. Therefore, jamming of the broken piece in the phase changing unit U and the like can be prevented.

In addition, as described earlier, a part of the rotating member 180 is formed as the resin member A2, and thus man-hour for machine processing of the rotating member 180 can be reduced, and therefore the reduction in cost can be achieved.

In addition, the reduction in weight of the rotating member 180 can be achieved and an inertial moment can be reduced, and thus the power saving of the electric motor D can be achieved. Furthermore, the resin member A2 and the metal member B2 are integrally molded by the insert molding, and thus a screw, a bonding agent, or the like for bonding is not required, and resin molding can be easily performed to the shape of a connection part corresponding to various drive shafts D1.

In the above embodiment, as rotating members included in the phase changing unit U, the rotating members 80 and 180 are shown which are molded articles obtained in a way that the resin members A and A2 and the metal members B and B2 are integrally molded by insert molding, but the present invention is not limited hereto.

For example, a resin member including a connection part made of resin and a metal member including an action part made of metal may be separately formed, the resin member and the metal member may be fastened by a resin screw and integrally bonded to form a rotating member, and the resin screw may function as a fragile part.
In addition, a resin member including a connection part made of resin and a metal member including an action part made of metal may be separately formed, the resin member and the metal member may be integrally bonded by a resin adhesive agent to form a rotating member, and the adhesive agent may function as a resin fragile part.
Furthermore, the resin fragile part may be a resin fragile part that is elastically deformed to allow idling of the drive shaft D1 even if the resin fragile part does not break, as long as the resin fragile part functions to cut the transmission of a rotational force.

In the embodiment, as a relative rotation mechanism which generates a relative rotation between the first rotating body and the second rotating body, a wave gear mechanism including the first internal gear 20 and the external gear 40 is shown, but the present invention is not limited hereto, and a planet gear mechanism, other speed reduction mechanisms, and the like can be used as long as the relative rotation mechanism is a mechanism that generates a relative rotation.

In the above embodiment, a structure is shown in which the second internal gear 60 is used and is rotated in-phase with the external gear 40 when a phase change is performed, but the present invention is not limited hereto, and a configuration may be used in which an external gear integrally including a tubular part having a row of teeth and a flange-like attachment part is used as the external gear, and the external gear integrally rotates with the second rotating body.

In the above embodiment, a case is shown in which the housing rotor 10 is used which has the cam shaft CS of the engine as the first rotating body and has the sprocket 11a interlocking with the crank shaft as the second rotating body, but the present invention is not limited hereto, and the rotating member of the present invention may be used in a configuration in which the housing rotor is applied as the first rotating body and the cam shaft CS is applied as the second rotating body.

In the above embodiment, a configuration is shown in which the bearing 70 is interposed between the external gear 40 and the rotating members 80 and 180, but the present invention is not limited hereto, and a configuration may be used in which the external gear 40 is directly fitted in the action part 84 as long as the action part 84 of the rotating members 80 and 180 can apply a cam action to the external gear 40.

In addition, as a bearing, the bearing 70 including the inner ring 71, the rolling body 73, and the outer ring 72 is shown, but the present invention is not limited hereto, and a configuration may be used in which a bearing is configured by an inner ring and a rolling body and the external gear 40 can be applied instead of the outer ring as long as manufacture is enabled and mechanical strength is ensured.

As described above, the phase changing unit of the present invention can achieve the simplification of structure, the reduction in weight, the reduction in noise, the reduction in cost, and the like, and can prevent damage to an electric motor and the like even when an excessive load has occurred, and thus not only can be applied as a phase changing unit of a valve timing changing device in an engine, but also can be applied as other speed reduction units, speed increase units, speed change units, or the like.

### REFERENCE SIGNS LIST

CS cam shaft (first rotating body)
S axis line
D electric motor
D1 drive shaft
D2 connection frame (drive shaft)
U phase changing unit
10 housing rotor (second rotating body)
11 first housing
11a sprocket
12 second housing
12a opening part
first internal gear (relative rotation mechanism)
Z1 number of teeth of first internal gear
30 rotor (spacer member)
40 external gear (relative rotation mechanism)
Z2 number of teeth of external gear
60 second internal gear
Z3 number of teeth of second internal gear
70 bearing
71 inner ring
72 outer ring
73 rolling body
80, 180 rotating member
A, A2 resin member
B, B2 metal member
82 connection part (fragile part)
84 action part
84a cam surface
182 connection part
183 fragile part

1. A phase changing unit, which changes a relative rotational phase of a first rotating body and a second rotating body that rotate around a predetermined axis line, comprising:
a rotating member to which a rotational driving force is applied as being connected with an external drive shaft; and
a relative rotation mechanism that generates a relative rotation between the first rotating body and the second rotating body by that the rotating member is rotated by the rotational driving force of the external drive shaft,
the rotating member comprising: an action part which is made of metal and acts on the relative rotation mechanism; a connection part which is made of resin and to which the external drive shaft is connected; and a fragile part which is made of resin and functions to cut a transmission of a rotational force between the external drive shaft and the rotating member when an excessive load has occurred.

2. The phase changing unit according to claim 1, wherein
with regard to the rotating member, a metal member comprising the action part and a resin member comprising the connection part and the fragile part are integrally bonded.

3. The phase changing unit according to claim 2, wherein
the rotating member is a molded article obtained in a way that the metal member and the resin member are integrally molded by insert molding.

4. The phase changing unit according to claim 1, wherein
the relative rotation mechanism comprises: a first internal gear which integrally rotates with the first rotating body; and an external gear which is annular, rotates integrally or in-phase with the second rotating body, has a number of teeth different from that of the first internal gear, and is elastically deformable due to an action of the action part so as to partially mesh with the first internal gear.

5. The phase changing unit according to claim 4, wherein
the action part comprises a cam surface which applies a cam action causing an elliptical deformation to the external gear.

6. The phase changing unit according to claim 5, wherein
the action part is fitted in the external gear via a bearing which is elliptically deformable.

7. The phase changing unit according to claim 6, wherein
the bearing comprises: an inner ring which is annular, and elastically deformable and in which the action part is fitted; an outer ring which is annular, elastically deformable and fitted in an inner side of the external gear; and a plurality of rolling bodies interposed between the inner ring and the outer ring.

8. The phase changing unit according to claim 4, comprising
a second internal gear which integrally rotates with the second rotating body and with which the external gear partially meshes.

9. The phase changing unit according to claim 8, wherein
a number of teeth of the second rotating body is the same as the number of the teeth of the external gear.

10. The phase changing unit according to claim 8, wherein
the second rotating body comprises a housing rotor which accommodates the relative rotation mechanism and the rotating member, and
the second internal gear is attached in a way of rotating integrally with the housing rotor.

11. The phase changing unit according to claim 10, wherein
the housing rotor is supported so as to be rotatable around the predetermined axis line via the first internal gear.

12. The phase changing unit according to claim 10, comprising:
a spacer member which is joined to the first rotating body, wherein
the first internal gear is fixed to the first rotating body via the spacer member, and the spacer member is formed in a way that a relative rotation range with respect to the housing rotor is controlled.

13. The phase changing unit according to claim 10, wherein
the housing rotor comprises: a first housing which has a cylindrical shape and has a sprocket on an outer periphery; and a second housing which has a disk shape, is bonded to the first housing and has an opening part that exposes the connection part of the rotating member.

14. A valve timing changing device for an engine, which comprises a phase changing unit changing a relative rotational phase of a cam shaft and a housing rotor interlocking with a crank shaft, and which changes an opening/closing timing of a valve for intake or exhaust driven by the cam shaft to an advanced angle side or a retarded angle side, wherein
the phase changing unit is the phase changing unit according to claim 1,
a first rotating body included in the phase changing unit is the cam shaft, and
a second rotating body included in the phase changing unit is the housing rotor.

15. The valve timing changing device according to claim 14, comprising
an electric motor which applies the rotational driving force to the rotating member included in the phase changing unit.

16. The valve timing changing device according to claim 14, wherein
the rotating member included in the phase changing unit is set to perform an advanced angle operation when the rotational driving force is applied at a rotational speed faster than a rotational speed of the cam shaft in a direction the same as a rotational direction of the cam shaft.
